(19) United States
(12) Patent Application Publication
(10) Pub. No.: US 2006/0280947 A1
(43) Pub. Date: Dec. 14, 2006

(54) Tungsten-including diamond-like carbon film and manufacturing method thereof, and dental device manufactured by the method

(75) Inventors: Kwang-Ryeol Lee, Seoul (KR); Ai-Ying Wang, Shen Yang City (CN)

Correspondence Address: DARBY & DARBY P.C., P. O. BOX 5257, NEW YORK, NY, 10150-5257, US

(73) Assignee: Korea Institute of Science and Technology, Seoul (KR)

(21) Appl. No.: 11/325,555

(22) Filed: Jan. 3, 2006

(30) Foreign Application Priority Data
Jun. 13, 2005 (KR) 10-2005-0050557

(51) Int. Cl. B32B 9/00

(52) U.S. Cl. 428/408

(57) ABSTRACT

A tungsten-including diamond like carbon film, comprises an amorphous carbon base of a film type; and tungsten added to the carbon base in an atomic state. A manufacturing method of a tungsten-including diamond like carbon film comprises: (a) fixing an objective body to a supporter in a vacuum chamber of complex coating equipment; and (b) spraying an ion beam toward the objective body and controlling a content of tungsten sputtered toward the objected body upon controlling an Ar fraction. A dental device coated with a tungsten-including diamond like carbon film, is manufactured by the aforementioned manufacturing method of a tungsten-including diamond like carbon film. According to such a structure, the carbon film and the objective body employing the film have the mechanical characteristic, and improved durability as the residual stress is lowered.

### BACKGROUND OF THE INVENTION

1. Field of the Invention

The present invention relates to a diamond-like carbon film, and more particularly, to a tungsten-including diamond-like carbon film and manufacturing method thereof, and a dental device manufactured by the method.

2. Description of the Background Art

A diamond-like carbon film is a coating material that is being used in various fields because of its high hardness, good lubricative property, high electric resistance and high abrasion resistance and also because of its very smooth surface and its synthesis at a low temperature. Also, its excellent chemical stability can gives a metallic material corrosion resistance.

Particularly, if a device like a dental drill that requires sterilization by high temperature and high pressure steam or undergoes performance degradation mainly due to the corrosion by saliva is coated with a diamond-like carbon film, the performance and lifespan of the drill can be greatly improved.

However, stable coating of the diamond-like carbon film is very difficult because of its high residual stress. Such high residual stress deteriorates an adhesive force of the diamond-like carbon film with a substrate, which causes separation from the substrate. Accordingly, it is important to reduce the residual stress while maintaining the high hardness of a hard carbon film in expanding application fields of the hard carbon film.

As a method for reducing the residual stress of the diamond-like carbon film, there are a method of forming a soft layer by bias control and forming a multi-layer structure, a method of forming multiple films by heat treatment, and a method of adding a third element.

However, in most cases, if the residual stress is reduced, a structure of a film is deteriorated, and thusly a mechanical property is also deteriorated. In addition, in order to apply the aforementioned methods, reconstruction of existing equipment or aftertreatment of a sample is necessary.

For this reason, a film that can maintain durability while maintaining mechanical excellency of the diamond-like carbon film without reconstruction of special equipment or aftertreatment and a manufacturing method thereof, is being continuously demanded.

### SUMMARY OF THE INVENTION

Therefore, an object of the present invention is to provide a tungsten-including diamond-like carbon film and manufacturing method thereof, and a dental device manufactured by the method for the purpose of increasing a lifespan of an objective body as coating of the objective body with a diamond-like carbon film having an excellent mechanical property is reliably maintained.

To achieve these and other advantages and in accordance with the purpose of the present invention, as embodied and broadly described herein, there is provided a tungsten-including diamond like carbon film, comprising: an amorphous carbon base of a film type; and tungsten added to the carbon base in an atomic state.

Here, preferably, the tungsten is added to an extent to which a second phase of the carbon base is not generated. The second phase is not generated when tungsten of 2.8 at. % or less is added.

From the view of hardness of the carbon film, preferably, tungsten of 2.2 at. % or less is added, and in order to have optimum residual stress, tungsten is preferably added within a range of 2.3˜3.3 at. %.

To achieve these and other advantages and in accordance with the purpose of the present invention, as embodied and broadly described herein, there is provided a manufacturing method of a tungsten-including diamond like carbon film comprises: (a) fixing an objective body to a supporter in a vacuum chamber of complex coating equipment; and (b) spraying an ion beam toward the objective body and controlling a content of tungsten sputtered toward the objective body upon controlling an Ar fraction.

Here, preferably, the supporter of the step (a) is configured to rotate, inclined at an angle of 5˜15° with respect to a direction that the ion beam is sprayed in the step (b).

Also, an ion source of the ion beam of the step (b) may be gasified benzene.

Furthermore, the tungsten content of the step (b) is preferably controlled within a range of 2.3˜3.3 at. %.

To achieve these and other advantages and in accordance with the purpose of the present invention, as embodied and broadly described herein, there is provided a dental device coated with a tungsten-including diamond like carbon film, wherein a surface of the dental device is coated according to the aforementioned manufacturing method of a tungsten-including diamond like carbon film.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a unit of this specification, illustrate embodiments of the invention and together with the description serve to explain the principles of the invention.

In the drawings:

FIG. 1 is a schematic view that illustrates complex coating equipment used in manufacturing of a carbon film in accordance with one embodiment of the present invention;

FIGS. 2A to 2D are views that illustrate electron-diffraction patterns of a carbon film according to a tungsten content;

FIG. 3A is a view that illustrates a change in residual stress according to a content of tungsten added to a carbon film in accordance with one embodiment of the present invention;

FIG. 3B is a view that illustrates a change in hardness according to a content of tungsten added to a carbon film in accordance with one embodiment of the present invention;

FIG. 4 is a view that illustrates a drilling test using a dental device coated with a carbon film in accordance with one embodiment of the present invention; and

FIG. 5 is a view that illustrates a change in edges of a dental device according to the test of FIG. 4.

### DETAILED DESCRIPTION OF THE PREFERRED EMBODIMENTS

Reference will now be made in detail to the preferred embodiments of the present invention, examples of which are illustrated in the accompanying drawings.

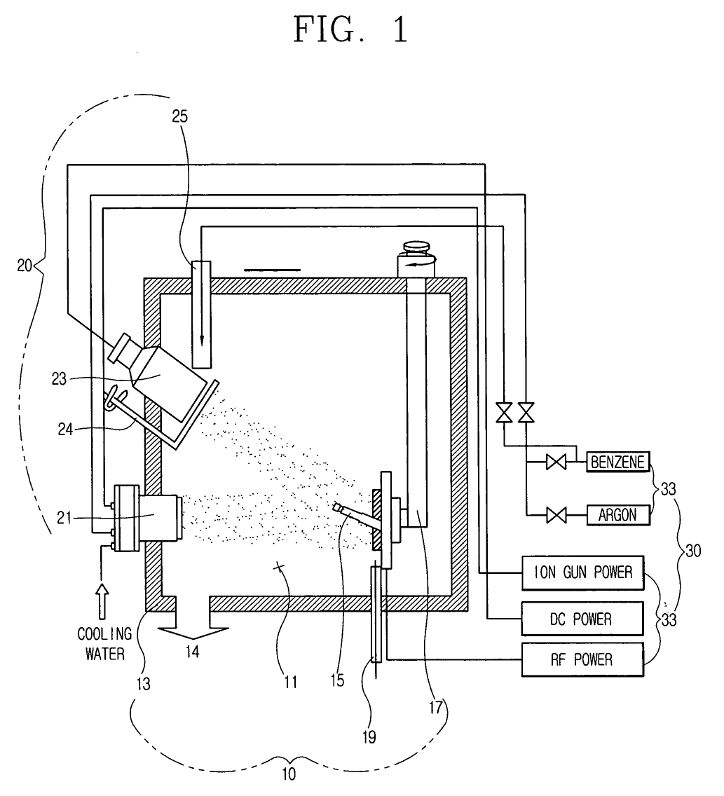

FIG. 1 is a schematic view that illustrates complex coating equipment used in manufacturing of a carbon film in accordance with one embodiment of the present invention.

As illustrated in the drawing, the complex coating equipment may be divided into a reaction chamber part 10, a spray part 20 and a control supply part 30.

First, the reaction chamber part 10 includes a casing 13 limiting a vacuum chamber 11 in which a substrate or an objective body 15 to be coated is placed, a vacuum pump 14 for maintaining vacuum of the vacuum chamber 11 at 10⁻⁶ torr or smaller, a supporter 17 for fixing the objective body 15 and a thermalcouple 19 which is a thermometer for measuring a temperature of the objective body 15.

The spray part 20 is a structure for spraying various ions or gases to the objective body 15 installed in the vacuum chamber 11, and includes an ion gun 21 installed to penetrate the casing 13 of the vacuum chamber 11, a sputter gun 23 and an inert gas supplier 25.

The ion gun 21 is an end-hall type ion gun and includes a tungsten filament for supplying thermal electrons and an anode for a plasma discharge, and a magnetic field for increasing a path of electrons is formed by a permanent magnet. The aforementioned filament is for discharging thermal electrons and is formed of tungsten, tantalum (Ta), or the like because it applies an electric current of tens of ampere (A) power and thusly increases a temperature up to approximately 200 degrees. If a voltage is applied to the anode while benzene gasified in a mass flow controller 31 is supplied through a supply line connected to the ion gun 21, plasma is generated by a large amount of electrons supplied from the filament, and ions within the plasma are pushed out by the voltage of the anode and are sprayed onto the substrate 15. Thusly, the energy of the sprayed ion is determined by the plasma voltage of the anode, and in most cases, a value of the energy is within a range of 90˜100 eV. 15 The sputter gun 23 is a common magnetron sputter gun, is installed at a position facing the substrate 15 at a certain angle thereto, and receives power from a sputter power supply system (DC power) 33. Tungsten is provided within the sputter gun 23. Also, a shutter 24 is installed in front of the sputter gun 23, prevents a target of the sputter gun 23 from being contaminated when only the ion gun 21 is used, and is necessary to wash a surface of the target of the sputter gun 23 before coating.

An inert gas supplier 25 is installed near the sputter gun 23. The amount of tungsten deposited to the objective 15 may be controlled by the flow of an insert gas introduced toward the sputter gun 23. As the inert gas, argon (Ar), helium (He), neon (Ne), krypton (Kr) or the like may be used. Argon, one of the gases, is supplied through a pipe line connected to the mass flow controller 31.

The control supply part 30 may be divided into a mass flow controller 31 and a power supplier 33. The mass flow controller 31 supplies gasified benzene to the ion gun 21 through the pipe line, and supplies argon to the inert gas supplier 25.

The power supplier 33 supplies power to the ion gun 21, the sputter gun 23 and the supporter 17 through a power cable. An RF power is for applying RF bias to the substrate 15.

A method for manufacturing a tungsten-including diamond-like carbon film by using the equipment of FIG. 1 will now be described.

First, an objective body 15 is fixed to the supporter 17 within the vacuum chamber 11 of the complex coating equipment.

Then, the ion gun 21 is moved to face the objective body 15 and sprays carbon and hydrogen ion gas beam obtained from gasified benzene of the mass flow controller 31.

The ion beam is sprayed in such a manner, and simultaneously, a tungsten ion is deposited to the objective body 15 by using the sputter gun 23. Also, an argon gas is sprayed toward the objective body 15 through the inert gas supplier 25. Here, for example, if the objective body 15 is a dental drill that is extended in a longitudinal direction, the objective body 15 is fixed to the supporter 17 so as to rotate, inclined at an angle of 5˜15 degrees with respect to the direction that tungsten is sprayed from the sputter gun 23. Accordingly, tungsten is evenly deposited onto the objective body 15.

In depositing of the tungsten ion, a content of tungsten contained in the objective body 15 is controlled by adjusting a fraction of argon of a mixed gas of a hydrocarbon gas and an argon gas.

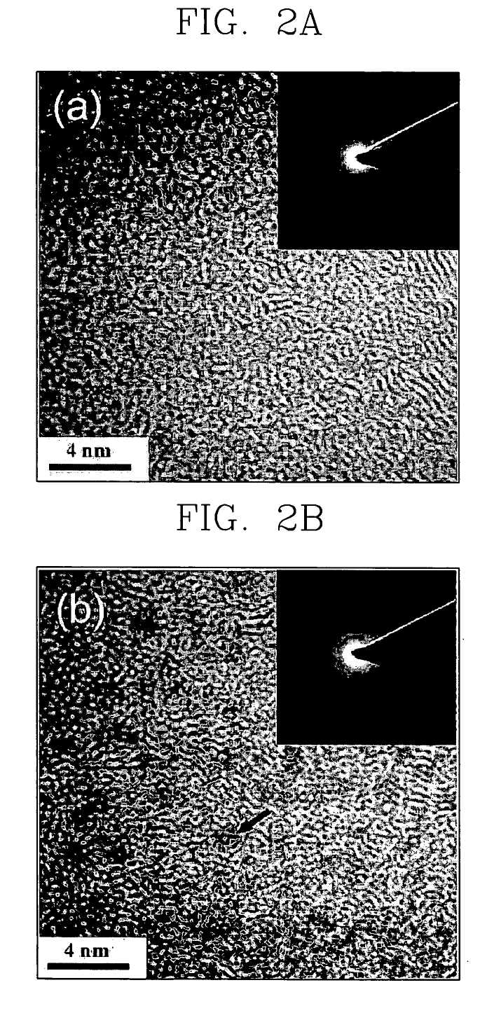

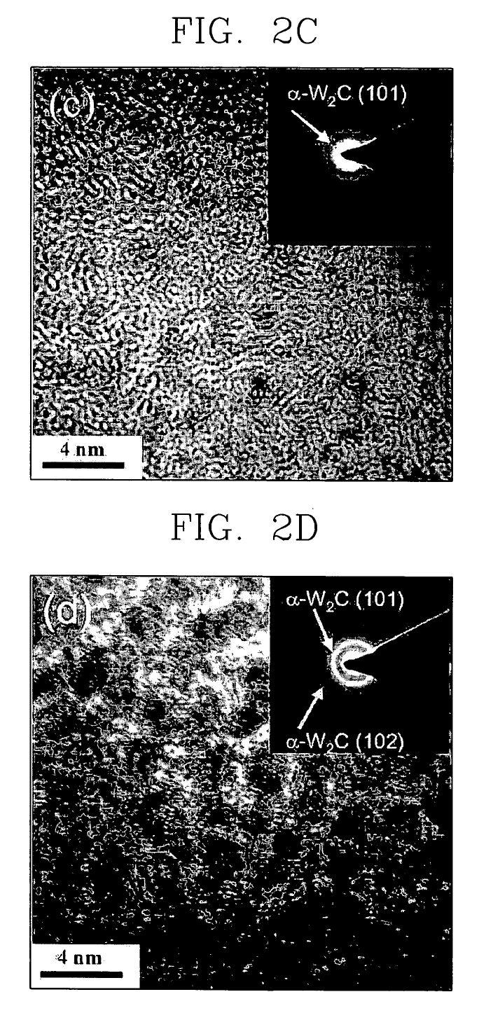

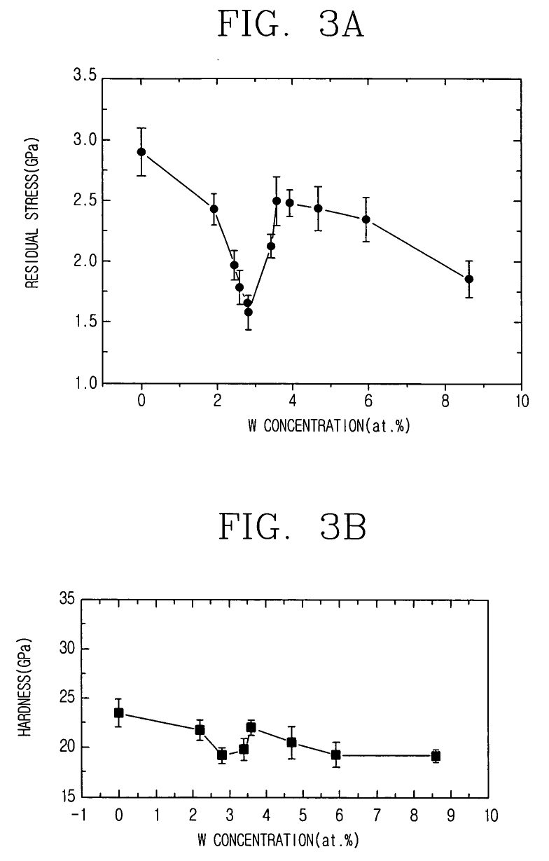

Such a tungsten content is a main factor in relation between hardness and residual stress of a carbon film, and description thereon will now be made with reference to FIGS. 2A to 2D and 3.

FIGS. 2A to 2D are views that illustrate electron-diffraction patterns of a carbon film according to a tungsten content (High-resolution TEM images and selected area electron diffraction patterns of a-C:H films with various W concentrations), FIG. 3A is a view that illustrates a change in residual stress according to a content of tungsten added to a carbon film in accordance with one embodiment of the present invention, and FIG. 3B is a view that illustrates a change in hardness according to a content of tungsten added to a carbon film in accordance with one embodiment of the present invention.

FIGS. 2A, 2B, 2C and 2D show whether the second phase of WC1-X in a carbon film is formed according to tungsten contents of 1.9 at. %, 2.8 at. %, 3.6 at. % and 8.6 at. %, respectively. FIG. 2A shows a single phase, FIG. 2B for the case where tungsten is added at approximately 2.8 at. % shows beginning of the emergence of the second phase, and FIGS. 2C and 2D show an increase of a ratio of the second phase as the amount of tungsten added is increased.

Residual stress and hardness of a tungsten-including carbon film according to such changes will now be described with reference to FIG. 3.

First, as shown in FIG. 3A, it can be seen that as a content of tungsten added to a carbon film is increased, residual stress is improved as compared to an initial state of non-adding.

In other words, the residual stress of a carbon film is approximately 2.7 GPa at an initial stage, and gradually decreases according to the addition of tungsten. If the tungsten content is approximately 2 at. %, the downward tendency of the residual stress is drastically increased. Then, if the tungsten content is approximately 2.8 at. %, the residual stress becomes about 1.5 GPa, which is a minimum value. According to the first principle calculation, as the tungsten atom functions as a pivot in such a structure, an increase in energy due to distortion of carbon combination is decreased. For this reason, it can be seen that the residual stress is reduced.

If tungsten of approximately 2.8 at. % or more is added, the residual stress shows an upward tendency, again.

According to such an upward tendency, the residual stress reaches about 2.4 Gpa at the moment when the tungsten content becomes approximately 3.6 at. %, and then the residual stress shows a downward tendency. However, even when the tungsten content is approximately 3.6 at. %, the maximum value is smaller than an initial value.

As described so far, adding tungsten to a carbon film brings a positive result from the view of residual stress, as compared to the case of not adding it.

However, adding of tungsten for reducing residual stress may deteriorates hardness of the carbon film, and this will now be described with reference to FIG. 3B.

As shown in FIG. 3B, like the residual stress, hardness of the carbon film also decreases according to adding of tungsten.

Furthermore, as in the case of the residual stress, the decrease has a form of gentle downward tendency-sudden downward tendency-sudden upward tendency-downward tendency. Also, as in the case of the residual stress, the hardness has a minimum value when approximately 2.8 at. % of tungsten is added.

However, by examining a ratio of an initial value to a minimum value, a difference therebetween and a reason for adding tungsten can be seen.

In other words, by the adding of tungsten, the residual stress decreases by approximately 45% from about initial 2.7 GPa to about 1.5 GPa while hardness decreases only by approximately 20% from about initial 23 GPa to about 18 GPa.

Consequently, the extent to which the residual stress decreases is twice greater than the extent to which the hardness decreases when tungsten is added to a carbon film.

Thusly, regarding to not only hardness of an objective body using carbon film coating but also durability, adding the certain amount of tungsten to a carbon film is advantageous in that an objective body having mechanical strength of a certain level can be used for a longer period of time.

From this point of view, a proper range of the amount of tungsten to be added is determined in consideration of hardness requested from the objective is body to be coated with a carbon film.

First, adding tungsten of approximately 2.8 at. % or less may be considered. If tungsten of approximately 2.8 at. % is added, as mentioned above, the residual stress decreases by approximately 45% as compared to the initial value while the hardness decreases only by approximately 20%.

Also, because the hardness shows a sudden downward tendency at a spot where the tungsten content is approximately 2.2 at. %, adding tungsten of less than 2.2 at. % may be considered. This is a selection range which can be regarded when the higher hardness is demanded. In this case, because the residual stress also shows a rapid downward tendency, selection of such a range is more preferable.

Also, adding tungsten within a range of about 2.3˜3.3 at. % may be considered. In such a case, the residual stress is within a range of about 1.5·2.0 GPa and has a value decreasing by approximately 45˜30% as compared to the initial value while the hardness is within a range of about 18˜22 GPa and decreases only by approximately 5˜20% as compared to the initial value. This range is particularly preferable when durability is more demanded than hardness is in reducing the residual stress.

The characteristics of the present invention will now be described through embodiments below, but the present invention is not limited thereby.

### Embodiment 1

Initial vacuum of a vacuum chamber 11 was 10 E-6 torr, gasified benzene was supplied to an ion gun 21 as an ion source, and an Ar gas for sputtering was supplied through an inert gas supplier 25. Simultaneously, tungsten was sprayed through a sputter gun 23. Thusly, deposition of a film was started. The amount of gas supplied was 40 sccm, and a tungsten content within the film was controlled by varying Ar/C6H6 from 0% to 90%. Particularly, by controlling Ar/C6H6 to 75%, a tungsten content of approximately 2.8 at. % was obtained. Here, as described with reference to FIG. 3, the residual stress and the hardness of the carbon film had minimum values.

### Embodiment 2

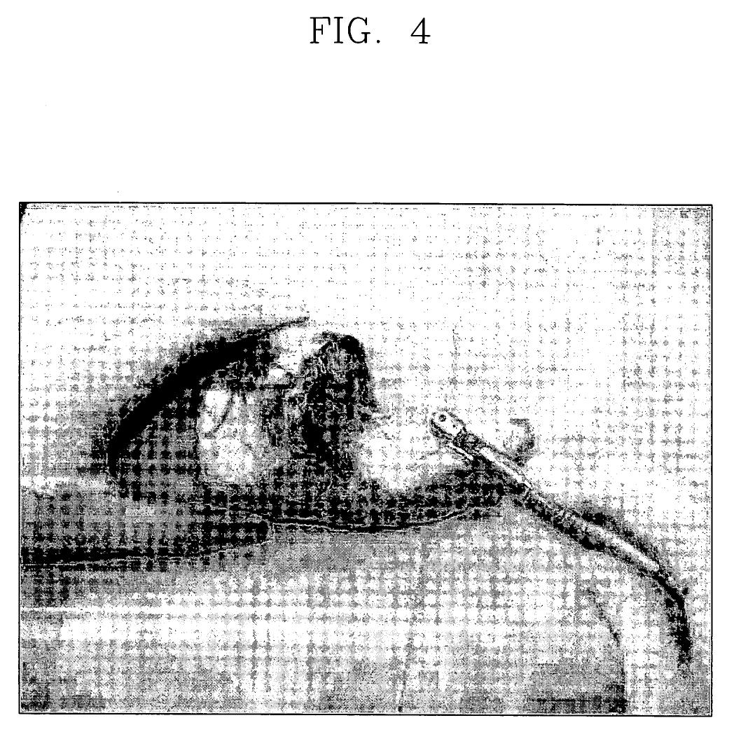

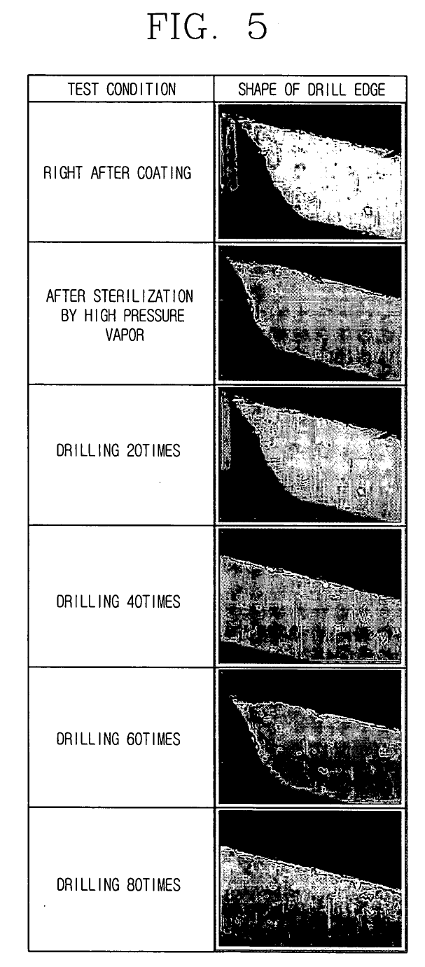

In the present embodiment, a dental device coated with the carbon film to which a certain range of tungsten is added according to the aforementioned method will now be described with reference to FIGS. 4 and 5.

FIG. 4 is a view that illustrates a drilling test using a dental device coated with a carbon film in accordance with one embodiment of the present invention, and FIG. 5 is a view that illustrates a change in edges of a dental device according to the test of FIG. 4.

In order to test performance of a dental device coated with a carbon film, for example, a coated drill, sterilization was performed in high pressure high temperature vapor for thirty minutes, and it was checked that no damage occurs to the coating layer in a sterilization process. Meanwhile, an oxidized layer had emerged on a portion of an edge of a drill which was not coated.

As shown in FIG. 4, in a drilling test using a pig's thigh bone, an existing drill could not be used more than 40 times because of its severe damage to its edge while a coated drill was not damaged even by drilling performed 80 times as shown in FIG. 5.

In the above description, a method in which an ion beam deposition and sputtering are combined is used as a synthesis method of a tungsten-including diamond like carbon film, but the present invention is not limited by this method. If a result that tungsten is included in a high-density amorphous carbon structure can be obtained, any method can be used and it can be said that the method falls within its spirit and scope of the present invention.

As described so far, a tungsten-including diamond-like carbon film and manufacturing method thereof, and a dental device manufactured by the method are advantageous in that various advantages of coating only with a carbon film can be maintained for a longer period of time by greatly reducing residual stress while maintaining mechanical strength at a certain level.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A tungsten-including diamond like carbon film, comprising:
an amorphous carbon base of a film type; and
tungsten added to the carbon base in an atomic state.

2. The carbon film of claim 1, wherein the tungsten is added to an extent to which a second phase of the carbon base is not generated.

3. The carbon film of claim 2, wherein the extent is 2.8 at. % or less.

4. The carbon film of claim 1, wherein the tungsten is added at 2.2 at. % or less.

5. The carbon film of claim 1, wherein the tungsten is added within a range of 2.3˜3.3 at. %.

6. A manufacturing method of a tungsten-including diamond like carbon film comprising:
(a) fixing an objective body to a supporter in a vacuum chamber of complex coating equipment; and
(b) spraying an ion beam toward the objective body and controlling a content of tungsten sputtered toward the objective body upon controlling an Ar fraction.

7. The method of claim 6, wherein the supporter of the step (a) is configured to rotate, inclined at an angle of 5˜15° with respect to a direction that the ion beam is sprayed in the step (b).

8. The method of claim 6, wherein an ion source of the ion beam of the step (b) is gasified benzene.

9. The method of claim 6, wherein the tungsten content of the step (b) is controlled within a range of 2.3˜3.3 at. %.

10. A dental device coated with a tungsten-including diamond like carbon film, wherein a surface of the dental device is coated according to a method of claim 6.
